(19) United States
(12) Patent Application Publication
(10) Pub. No.: US 2018/0287108 A1
(43) Pub. Date: Oct. 4, 2018

(54) CYLINDRICAL CELL TOGGLE HOLDER

(71) Applicant: NextEV USA, Inc., San Jose, CA (US)

(72) Inventor: Austin L. Newman, San Jose, CA (US)

(21) Appl. No.: 15/472,923

(22) Filed: Mar. 29, 2017

(51) Int. Cl. H01M 2/10; H01M 10/0525

(52) U.S. Cl. CPC H01M 2/1016; H01M 10/0525

(57) ABSTRACT

Methods and systems are provided for mounting cylindrical battery cells together into a battery. Systems are provided for securing cylindrical battery cells by a crimped region allowing for a strong contact point while strongly holding a cell in a battery. Cut-out style and tabbed or extending engagement mounting devices are disclosed allowing for access to a top terminal of a cell. Matrix style mounting devices are disclosed for arranging battery cells in a number of configurations.

### FIELD

The present disclosure relates generally to battery systems and more particularly to methods and systems of mounting and interconnecting battery cells.

### BACKGROUND

Cars, other vehicles and large machines, and other portable electric devices utilize battery power. As cars and other vehicles move away from the burning of gasoline and towards more clean energy sources, batteries are increasingly being used for power.

Because batteries of custom size and power are costly, large batteries are typically made from a number of interconnected cells. For example, many car batteries, laptop batteries, flashlight batteries, etc. are made from a number of series-connected cylindrical lithium-ion rechargeable battery cells. One such cell is the 18560 Li-ion size cell.

The manufacturing process for building banks of battery cells conventionally comprises using a plastic, or other material, housing to mount the cells together. Alternatively, battery cells may be glued or taped together.

Methods of mounting cells together, however, create a number of problems. For example, methods of physically gluing or taping battery cells together create issues associated with proper heat dissipation and inefficient manufacturing processes. Also, methods of using plastic, or other materials, to create a housing typically create bulky, space-wasting assemblies. All conventional methods of mounting cells together to form a battery result in unstable batteries in which cells constantly come loose and become unconnected with the rest of the battery. Also, currently methods of mounting cells together are costly and inefficient manufacturing processes.

### BRIEF DESCRIPTION OF THE DRAWINGS

FIG. 1A illustrates a side view portion of a battery cell as used with certain embodiments of the present disclosure;

FIG. 1B illustrates a plan view of a battery cell including a contact terminal as used with certain embodiments of the present disclosure;

FIG. 1C illustrates a partial perspective view of a battery cell as used with certain embodiments of the present disclosure;

FIG. 2 illustrates a battery mounting device attached to a battery cell in accordance with an embodiment of the disclosure;

FIG. 3A illustrates an arm portion of a battery mounting device in accordance with an embodiment of the disclosure;

FIG. 3B illustrates an alternative arm portion of battery mounting device in accordance with an embodiment of the disclosure;

FIG. 3C illustrates an alternative arm portion of a battery mounting device in accordance with an embodiment of the disclosure;

FIG. 3D illustrates an alternative arm portion of a battery mounting device in accordance with an embodiment of the disclosure;

FIG. 3E illustrates an alternative arm portion of a battery mounting device in accordance with an embodiment of the disclosure;

FIG. 3F illustrates a plan view of an alternative battery mounting device in accordance with an embodiment of the disclosure;

FIG. 3G illustrates a plan view of an alternative battery mounting device in accordance with an embodiment of the disclosure;

FIG. 3H illustrates a plan view of an alternative battery mounting device in accordance with an embodiment of the disclosure;

FIG. 3I illustrates a perspective view of a matrix-style mounting device for receiving a plurality of cells in accordance with an embodiment of the disclosure;

FIG. 3J illustrates a perspective view of a matrix-style mounting device for receiving a plurality of cells in accordance with an embodiment of the disclosure;

FIG. 3K illustrates a perspective view of a matrix-style mounting device for receiving a plurality of battery cells in accordance with an embodiment of the disclosure;

FIG. 3L illustrates a plan view of a matrix-style mounting device for receiving a plurality of battery cells in accordance with an embodiment of the disclosure;

FIG. 4 illustrates a battery mounting device and a portion of a battery cell in accordance with an embodiment of the disclosure;

FIG. 5A illustrates a battery mounting device and a portion of a battery cell prior to attachment in accordance with an embodiment of the disclosure;

FIG. 5B illustrates a battery mounting device in the process of attaching to a battery cell in accordance with an embodiment of the disclosure;

FIG. 5C illustrates a battery mounting device attached to a battery cell in accordance with an embodiment of the disclosure;

FIG. 6A illustrates a plan view of a matrix-style mounting device for receiving a plurality of battery cells in accordance with an embodiment of the disclosure;

FIG. 6B illustrates a detail plan view of a mounting device for receiving a single battery cell as depicted in FIG. 6A in accordance with an embodiment of the disclosure;

FIG. 6C illustrates a side-view of a battery mounting device including a number of attached battery cells in accordance with an embodiment of the disclosure;

FIG. 6D illustrates a side-view of a battery mounting device for receiving a number of battery cells in accordance with an embodiment of the disclosure;

FIG. 6E illustrates a side-view of a battery mounting device for receiving a number of battery cells in accordance with an embodiment of the disclosure;

FIG. 7 illustrates a side-view of a battery mounting device for a receiving number of battery cells in accordance with an embodiment of the disclosure;

FIG. 8 illustrates a perspective view of a battery mounting device for receiving a matrix of battery cells and a number of battery cells disposed apart from the battery mounting device prior to attachment in accordance with an embodiment of the disclosure; and

FIG. 9 illustrates a perspective view of a battery mounting device for receiving a matrix of battery cells and a number of battery cells disposed apart from the battery mounting device prior to attachment in accordance with an embodiment of the disclosure.

### DETAILED DESCRIPTION

Embodiments of the present disclosure will be described in connection with a mounting system for battery cells to be used in a battery.

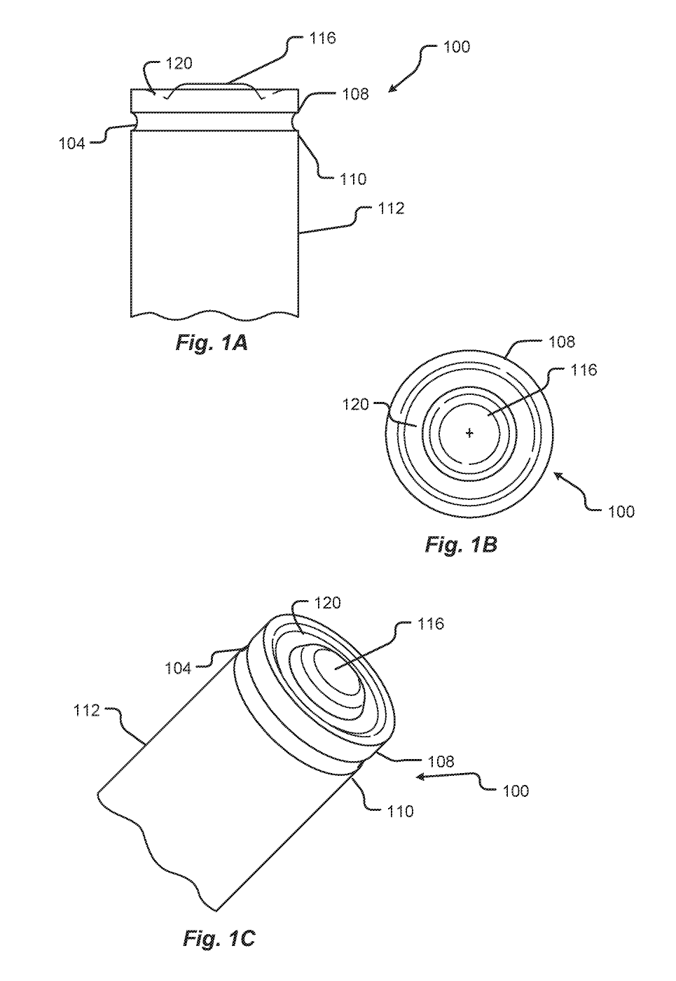

A battery cell 100 as which may be used in some embodiments is illustrated in FIGS. 1A-1C. One example battery cell is the type 18650 cell, however other types may also be used in certain embodiments. Generally, a cylindrical battery cell 100 as illustrated in FIGS. 1A-1C may be used. Methods of manufacturing cylindrical battery cells as known in the art leave a crimped region 104 near the top portion 108 of the sidewall 112.

As illustrated in FIG. 1A, the crimped region 104 may be of a V-shape or valley shape or may be a smooth ditch shape. In some embodiments, the crimped region 104 may include a radius or rounded interior surface. The crimped region 104 may partially or completely circumscribe a portion of the battery cell 100 and the crimped region 104 may have a smaller radius from the center of the cell 100 as compared to the rest of the sidewall 112. The crimped region 104 may separate a bottom portion 110 of the sidewall 112 from a top portion 108 of the sidewall 112.

A plan view of a battery cell 100—as illustrated in FIG. 1A—is illustrated in FIG. 1B. As can be appreciated, the battery cell 100 may have a positive terminal 116 at the top. The terminal 116 may be portioned away from the top portion 108 of the sidewall 112 by a valley 120 or some other separation element. In many cases, the sidewall 112 may also act as a ground (GND) contact point. The GND contact point may be at one or more of the top portion 108, the bottom portion 110, on the crimped region 104, and/or any or all points on the sidewall 112.

As illustrated in FIG. 1C, the crimped region 104 of the battery cell 100 may be a valley shape circumscribing the circumference of the battery cell 100 and cut into the sidewall 112 and separate the bottom portion 110 of the crimped region 104 from the top portion 108 of the sidewall 112.

Conventional methods of stacking battery cells or using plastic housing to combine cells into batteries ignore the crimped region of the structure of the sidewall of a cell. The issues with the conventional methods, as discussed in the background, can be resolved with the present disclosure which utilizes the crimped region as a structural element to achieve a strong contact point. By utilizing the crimped region of a battery cell, a system as disclosed herein can be used to securely grasp and hold one or more battery cells. Such a system may result in a highly-efficient and low-cost method of manufacturing a battery comprising a number of battery cells.

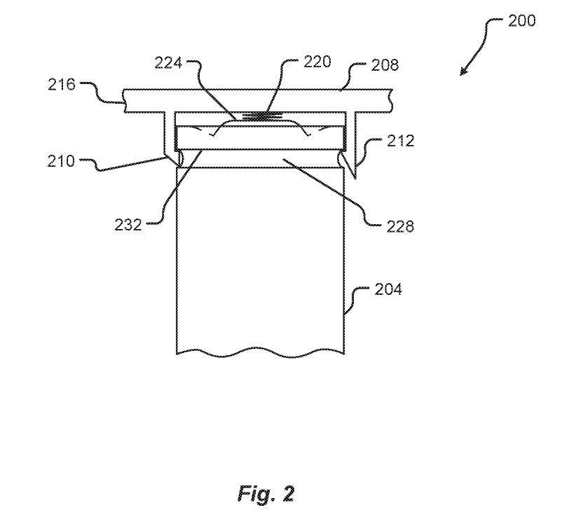

As illustrated in FIG. 2, a system 200 of mounting a battery cell 204 may in some embodiments comprise a mounting element 208 with two or more retaining elements 210 and 212 extending downward from a top plate 216. The top plate 216 may have one or more contact points 220 for contacting a positive terminal 224 of the battery cell 204. For example, the contact point 220 may be a spring or a metal reed or some other flexible or inflexible element operable to touch the positive terminal 224 and conduct electricity. In some embodiments, the contact point 220 may be spring-like or retractable such that the mounting element 208 may accept battery cells of various lengths or battery cells with crimped regions. The contact point 220 may also be in contact with a substrate running through the top plate 216 and operable to connect the positive terminal 224 of the battery cell 204 with terminals of other battery cells to form a battery of multiple cells.

The retaining elements 210 and 212 may extend from the top plate 216 down to the crimped region 228 of an engaged, or retained, battery cell 204. The retaining elements 210 and 212 may be of a shape such that the battery cell 204 is operable to slide into the welcoming retaining elements 210 and 212 which may be operable to lock into the crimped region 228. For example, the lowest point of each retaining element 210 and 212 may be pointed and/or shaped away from the sidewall of the battery cell 204. In one embodiment, one or more of the retaining elements 210, 212 may include a shaped edge having at least one chamfered, angled, and/or rounded surface. This shaped edge may serve to easily receive and/or retain a battery cell 204. For instance, as a battery cell 204 is moved toward and into contact with the shaped edge, the retaining elements 210, 212 may displace around an upper portion of the battery cell 204 and then clip into, or otherwise engage with, the crimped region 228 of the battery cell 204. Once engaged with the retaining elements 210, 212, at least one degree of freedom for the battery cell 204 may be restricted. By way of example, the retaining elements 210, 212 may include at least one feature and/or surface that prevents the battery cell 204 from being removed from the engaged position in the retaining elements 210, 212 without displacing, flexing, or otherwise manipulating a position of the retaining elements 210, 212 contacting the crimped region 228 of the battery cell 204. The retaining elements 210 and 212 may have a lip feature operable to catch an upper edge 232 of the crimped region 228 as the battery cell 204 is slid into the mounting element 208 through and by the retaining elements 210 and 212. While in FIG. 2 only two retaining elements 210 and 212 are illustrated, a mounting element may have any number of retaining elements. In certain embodiments, each mounting element may have three retaining elements for each battery cell.

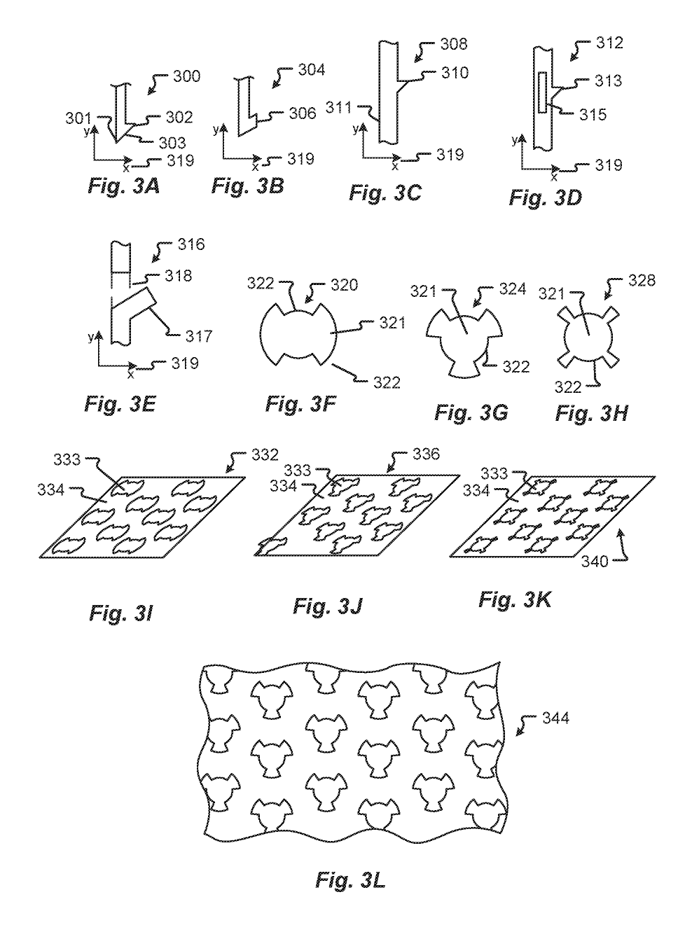

A number of various shapes of retaining elements in accordance with certain embodiments are illustrated in FIGS. 3A-3H. In certain embodiments, the retaining elements may be one of two types: tabbed or cut-out. The first type, tabbed, may be as illustrated in FIGS. 3A-3E. The second type, cut-out, may be as illustrated in FIGS. 3F-3H. Both the tabbed and cut-out types operate in similar fashions—retaining elements, toggles, clips, or some other type of extension of a mounting device, protrudes toward a lip, groove, trough, recess, or some other type of indentation on a battery cell created from the crimping.

As illustrated in FIG. 3A, a retaining element 300 may have a first point 301 which may be situated on a side away from the battery cell to be attached and a second point 302 toward the battery cell to be attached. A chamfered surface, or sloped area 303, may extend between the two points 301 and 302 and may act as or guiding element when a battery cell is inserting into the mounting device. For example, as a battery cell is slid into the mounting device 300, a top side of the battery cell may press against the sloped area 303 and press the retaining element 300 out and away from the battery. When the battery cell is slid up and into the mounting element, the second point 302 may slide against the sidewall and upon hitting the crimped region of the battery cell press into the crimped region and lock the battery cell in place.

As illustrated in FIG. 3B, in certain embodiments a retaining element 304 may have a flat portion 306 operable to fit into a crimped region of a battery cell instead of merely a point. The upper point of the flat portion 306 may act to press against an upper point of a crimped region of a battery cell and hold the battery cell in place.

Note that the FIGS. 3A-3E show exemplary retaining elements in a side profile only. As shown in FIGS. 3A-3E, the coordinate system 319 defines an X-axis running in a horizontal direction, a Y-axis running in a vertical direction. A Z-axis may run in a direction orthogonal and perpendicular to the X-Y plane shown (e.g., into and/or out of the page). In some embodiments, the retaining elements may extend in a z-direction to some depth.

As illustrated in FIG. 3C, in certain embodiments a retaining element 308 may comprise a flat side portion 311 extending down and parallel to a sidewall of a mounted battery cell. Such a retaining element 308 may have a pointed toggle region 310 operable to insert into a crimped region of a battery cell upon mounting.

As illustrated in FIG. 3D, in certain embodiments a retaining element 312 may comprise a hollow, or cut-out portion 315 behind a pointed toggle region 313. A hollow, or cut-out portion 315 may operate to allow a pointed toggle region 313 of a retaining element 312 to flexibly bend away from an inserted battery cell and to flexibly bend back into the sidewall of the battery cell upon meeting the crimped region.

As illustrated in FIG. 3E, a retaining element 316 may be created from a solid flat plane by punching out a section 317 and leaving an open portion 318. The section 317 may act as a retaining toggle switch operable to contact a crimped region of a battery cell and hold the battery cell in place.

In addition to or in place of a downward extending retaining element, the battery holding device in certain embodiments may consist of a flat plane with holes shaped to allow a battery cell to be pressed partially through the plane until held in place by one or more flat toggle areas contacting the crimped recess region of the battery cell.

As illustrated in FIGS. 3F-3H, the retaining element 320, 324, 328 may in some embodiments be a hole 321 in a flat plane with one or more toggle areas 322. As illustrated in FIG. 3F, a retaining element 320 may in some embodiments have two toggle areas 322. When a battery cell is inserted into the hole 321, the toggle areas 322 may bend and allow entry. As the battery cell slides up, a crimped region of the battery cell may reach the flat plane level of the retaining element 320 at which point the toggle areas 322 may contract or bend inward into the crimped region and lock the battery cell in place. Electrical contact points and/or substrates may be placed on or in the flat planes and may make contact with battery cell sidewalls via contact points on the toggle areas 322 allowing for a common ground connection to be made from one cell to another.

As illustrated in FIG. 3G, in certain embodiments a retaining element 324 may have three toggle areas 322. As illustrated in FIG. 3H, in certain embodiments a retaining element 328 may have four toggle areas 322. In other embodiments not illustrated, a retaining element may have more than four toggle areas.

As illustrated in FIGS. 3I-3L, certain embodiments may comprise multiple retaining elements which may be connected together to form a matrix of inter-connected battery cells. The battery cells may be connected electrically in series or in parallel and may together form a single battery. The flat plane area may form a solid ground (GND) connection via an inlaid substrate running on or in the flat plane and making contact with the sidewalls of each mounted battery cell. The positive terminals of each battery may be accessed by other means from above the flat plane area, allowing for an interconnection of all battery cells. In some embodiments, the mounting elements may be arranged to space the retained battery cells a certain distance from one another. Among other things, this spacing can provide a designed and/or uniform cooling path between each of the retained battery cells.

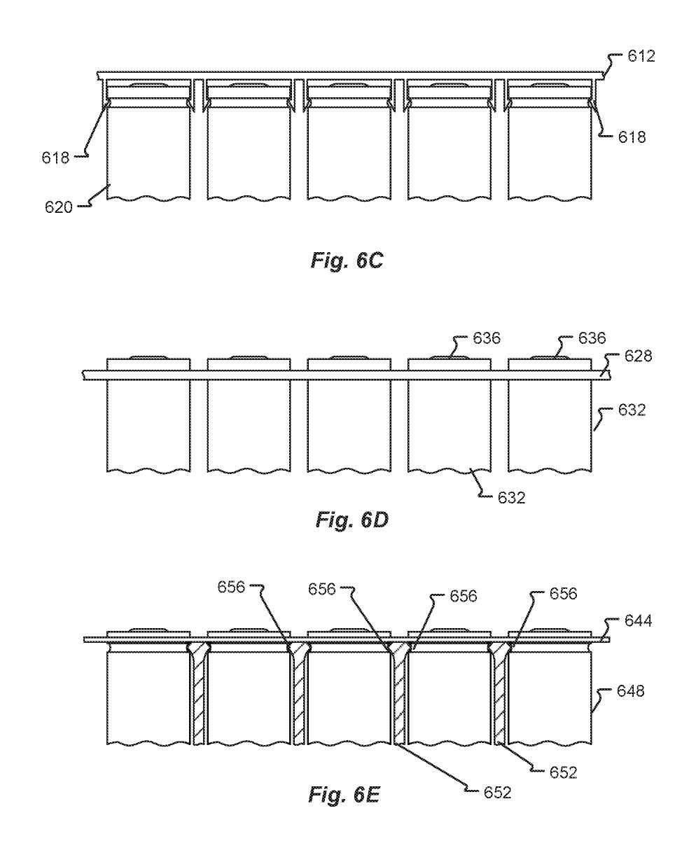

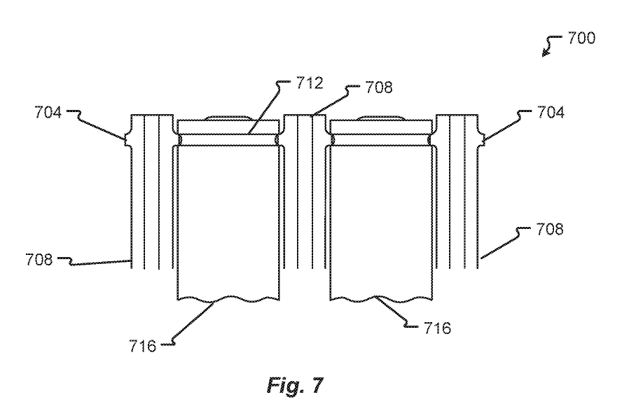

While FIGS. 3I-3L illustrate cut-out mounting designs, matrices of mounted devices may be made with the extending retaining element designs as illustrated in FIGS. 6C-6E and FIG. 7.

FIG. 3I illustrates an angled plan view of a matrix-style mounting device for a plurality of cells in accordance with an embodiment of the disclosure. As can be appreciated, each mounting element 333 may comprise two toggle switches as illustrated in more detail in FIG. 3F. In certain embodiments, the entire plane 334 may act as a GND connection, connecting all mounted cells to a common ground. In other embodiments, a substrate may be included to electrically connect each battery cell together.

FIG. 3J illustrates an angled plan view of a matrix-style mounting device for a plurality of cells in accordance with an embodiment of the disclosure. As can be appreciated, each mounting element 336 may comprise three toggle switches as illustrated in more detail in FIG. 3G.

FIG. 3K illustrates an angled plan view of a matrix-style mounting device for a plurality of cells in accordance with an embodiment of the disclosure. As can be appreciated, each mounting element 340 may comprise four toggle switches as illustrated in more detail in FIG. 3H.

FIG. 3L illustrates a plan view of a matrix-style mounting device 344 for a plurality of cells in accordance with an embodiment of the disclosure. Alternative view of such a configuration may be seen in FIG. 3J and a detailed close-up view of one mounting element to be used in such a configuration may be as illustrated in FIG. 3G.

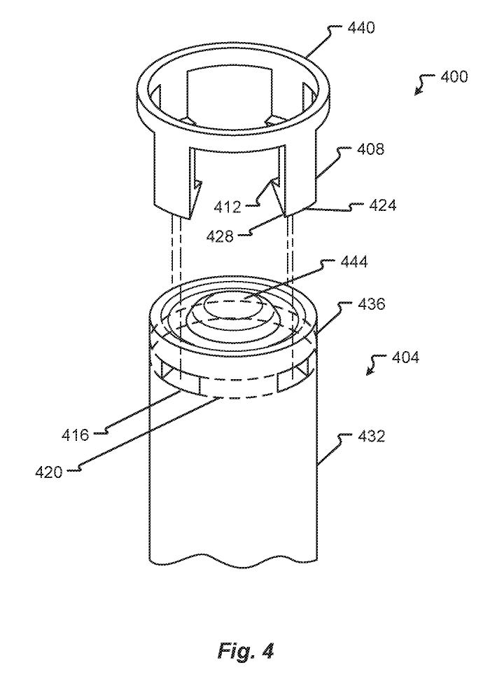

FIG. 4 illustrates a battery mounting device 400 and a portion of a battery cell 404 in accordance with an embodiment of the disclosure. As can be appreciated, a battery mounting device 400 may in certain embodiments comprise a number of downward extending retaining elements 408. The retaining elements 408 may be of a sufficient or particular length such that an interior point 412 may reach a portion 416 of a crimped region 420 of a battery cell 404 when the battery cell 404 is inserted into the battery mounting device 400. Alternatively, the battery mounting device 400 may be slid onto the battery cell 404. Whether the battery mounting device 400 is slid onto the battery cell 404, or the battery cell 404 is inserted into the battery mounting device 400, the movement may be guided by the one or more downward extending retaining elements 408.

The downward extending retaining elements 408 may be of a particular width 424 such that sufficient contact by the downward extending retaining elements 408 may be made with the crimped region 420.

As the battery cell 404 comes into contact with the retaining elements 408, the edge of each retaining element between the interior point 412 and the bottommost point 428 may be pressed against causing each retaining element 408 to press outward, away from the battery cell 404. The interior point 412 may, upon reaching the level of the crimped region 420, effectively lock into the crimped region 420 and act to hold the battery cell 404 in the mounting device 400.

While in some embodiments, the top portion 440 of the mounting device 400 may be closed and contain an electrical contact point for connecting with the positive terminal 444 of the battery cell 404, the top portion 440 may in some embodiments be open and allow access to the positive terminal 444.

The downward extending retaining elements 408 may be metal or otherwise contain an electrical conducting surface allowing for a ground connection to be made with the sidewall 432 of the battery cell.

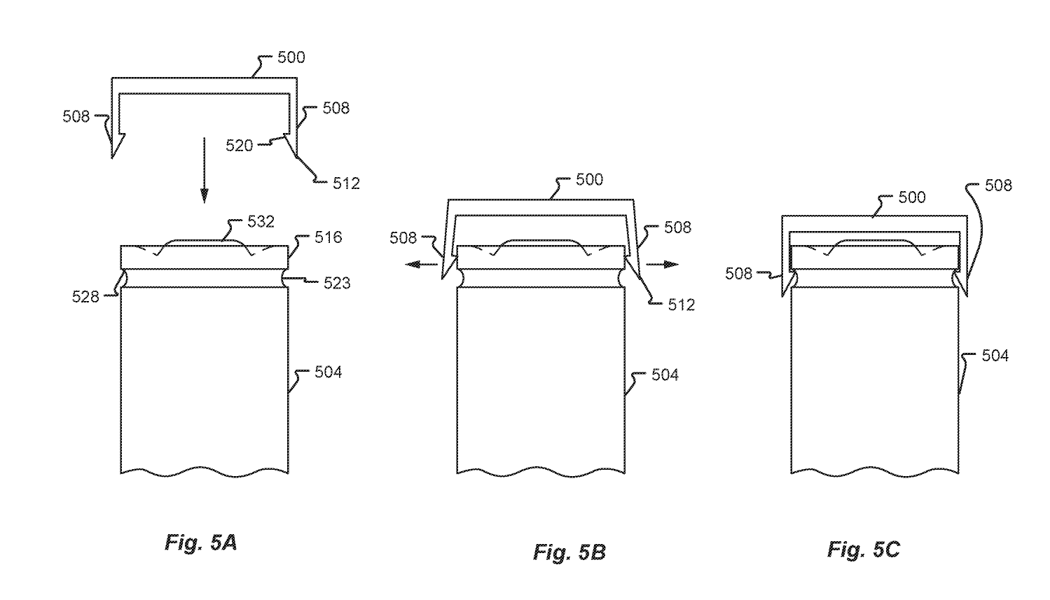

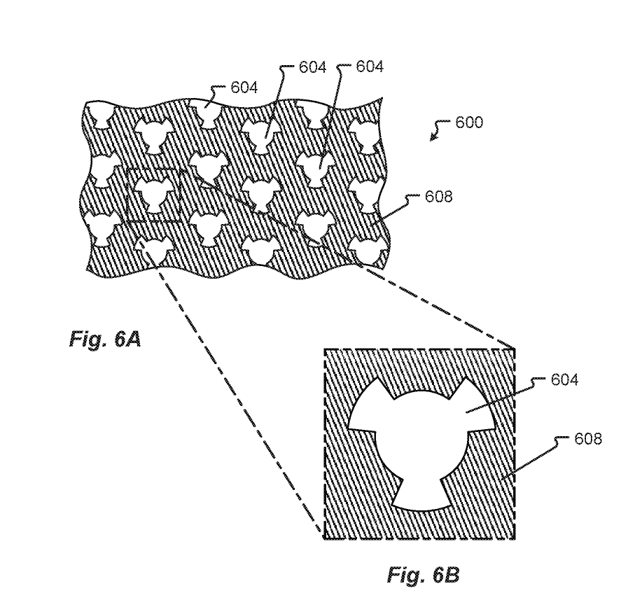

An exemplary method of mounting a battery cell in accordance with certain embodiments of the present disclosure is illustrated in FIGS. 5A-5C. In general, the mounting comprises three steps.

A process of mounting a battery cell mounting device 500 onto a battery cell 504 begins with a configuration as illustrated in FIG. 5A. As can be appreciated, the battery cell mounting device 500 may be placed over the top of the battery cell 504.

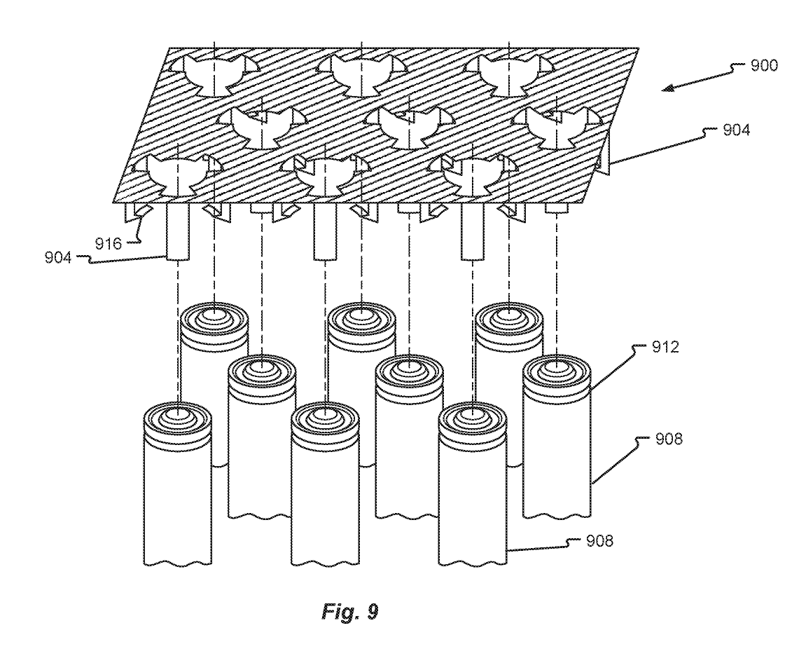

In certain embodiments, the battery cell mounting device 500 may be only one of a number of battery cell mounting devices connected in a matrix. In such embodiments, and as illustrated in FIG. 9, each battery cell mounting device may be associated with a particular battery cell.

When a battery cell mounting device 500 is placed over a battery cell 504 to be mounted, the retaining elements 508 may be arranged along the outer edge of the battery cell 504. In certain embodiments, an outer point 512 of each retaining element may be wider than an outer upper edge 516 of the battery cell 504. Such a configuration may allow each retaining element 508 to spread out as the mounting device 500 is placed onto the top of a battery cell 504 as illustrated in FIG. 5B.

As can be appreciated from the illustration in FIG. 5B, the retaining elements 508 may extend outward as the upper outer edge 516 presses against the edge of each of the retaining elements 508 running between the outer point 512 to the inner point 520. As the mounting device 500 is lowered further onto a battery cell 504, the inner point 520 of each of the retaining elements 508 may meet a crimped region 524 of the battery cell 504. As the inner point 520 of a retaining element 508 enters the crimped region 524 of the battery cell 504, the retaining element 508 may flex inward toward the battery cell 504 and the inner point 520 may enter the crimped region 524 as illustrated in FIG. 5C. The battery cell 504 may as a result be locked into the mounting device 500 due to the inner point 520 of the retaining element 508 contacting the upper edge 528 of the crimped region 524 of the battery cell 504.

FIG. 6A illustrates a plan view of a matrix-style mounting device 600 for a plurality of cells in accordance with an embodiment of the disclosure. As can be appreciated, each mounting element 604 may comprise three toggle switches as illustrated in more detail in FIG. 6B. In certain embodiments, the entire plane 608 may act as a ground connection, connecting all mounted cells to a common ground. In other embodiments, a substrate may be included to electrically connect each battery cell together.

FIG. 6C illustrates a side-view of a battery mounting device 612 for a number of cells 620 in accordance with certain embodiments of the disclosure. As can be appreciated, the battery mounting device 612 may comprise of a series of retaining elements 618. While the mounting device 614 in FIG. 6C is illustrated from a side view and shows a straight line of battery cells 620, it should be clear to one of ordinary skill in the art that a battery mounting device 612 may be configured such that the battery cells 620 may be in any configuration. A substrate may be implemented within or on the mounting device 612 and the retaining elements 618 may comprise an electrical contact point or be of a conducting material such that a ground connection may be made connecting a number of the mounted battery cells.

In certain embodiments, a cut-out style mounting system 628 may be implemented as illustrated in FIG. 6D. As can be appreciated, each battery cell 632 may be inserted through holes in the mounting system 628 such that the top portion 636 of each battery cell 632 may be accessible and rest over the top of the mounting system 628. Such a mounting system 628 may be as illustrated in FIGS. 3I-3L. The battery mounting device 628 may, when connected to one or more battery cells, be parallel and level with the crimped region of any mounted cells 632. While the mounting device 628 in FIG. 6D is illustrated from a side view and shows a straight line of battery cells 632, it should be clear to one of ordinary skill in the art that a battery mounting device 628 may be configured such that the battery cells 632 may be in any configuration.

Another embodiment as illustrated in FIG. 6E may comprise a battery mounting system 644 with holes to allow the entry of a number of battery cells 648 as well as partition elements 652. The partition elements 652 may comprise shaped points 656 operable to insert into a crimped region of a mounted battery cell 648. The partition elements 652 may also act as heat dissipation elements.

A more detailed illustration of a similar embodiment is shown in FIG. 7. As can be appreciated, a battery mounting system 700 may comprise a number of partition elements 708 with a number of points 704 configured to press into a crimped portion 712 of a mounted battery 716. The partition elements 708 may operate to dissipate heat and/or stabilize the cells 716 of the battery.

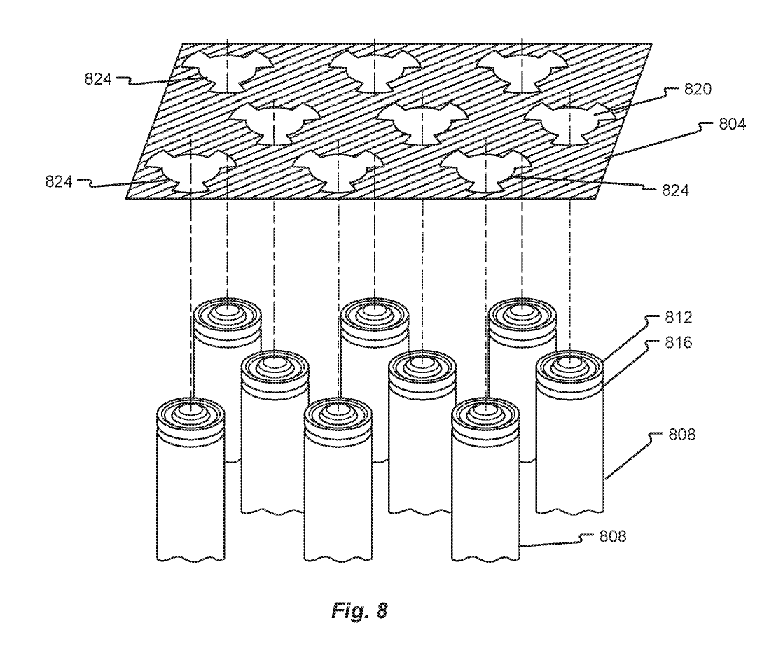

FIG. 8 illustrates a matrix of cut-out style mounting devices for mounting a number of battery cells 808. As can be appreciated, the matrix plane 804 may comprise a hole 820 for each of the battery cells 808 to be mounted. As the mounting device matrix 804 is lowered onto the battery cells 808 or a battery cell 808 is pressed into a hole 820, the top portion 812 of the battery cell 808 may enter and pass through the plane of the matrix 804 and one or more toggles 824 surrounding the hole 820 may contact and securely hold the battery cell 808 at the crimped portion 816.

Illustrated in FIG. 9 is a matrix 900 of downward extending retaining elements 904 for mounting a number of battery cells 908. As discussed in further detail herein, inward points 916 of each downward extending retaining element 904 may contact and securely hold a crimped region 912 of each battery cell 908. The matrix 900 may be pressed downward onto a number of battery cells 908. Alternatively, each battery cell 908 may be inserted into the retaining elements 904.

Any of the steps, functions, and operations discussed herein can be performed continuously and automatically.

The exemplary systems and methods of this disclosure have been described in relation to the figures. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a battery cell mounting device, comprising: a substantially planar substrate; a cutout disposed in a portion of the substrate; and a plurality of battery cell retaining elements formed at a periphery of the cutout and in the substrate, wherein at least one of the plurality of battery cell retaining elements comprises a flexible region disposed at the periphery of the cutout, the at least one of the plurality of battery cell retaining elements having a first flexed battery cell receiving state and a second flexed battery cell retaining state, and wherein the plurality of battery cell retaining elements include a battery cell engagement feature sized to engage with and retain a crimped region of an attached battery cell.

Aspects of the above method include wherein an upper portion of the mounted battery cell extends above the substrate.

Aspects of the above method include wherein the one or more flexible retaining elements extend offset from the substrate in a direction toward the crimped region.

Aspects of the above method include wherein a contact point connected to a second substrate is operable to electrically contact a positive terminal of the mounted battery cell.

Aspects of the above method include wherein the one or more flexible retaining elements comprise a hollow portion, wherein the hollow portion allows for a horizontal movement of the one or more flexible retaining elements.

Aspects of the above method include wherein the one or more flexible retaining elements comprise an interior point operable to hold the mounted battery cell at the crimped region.

Aspects of the above method include wherein the battery cell mounting device is connected to at least a second battery cell mounting device via the substrate.

Embodiments include an energy storage system, the energy storage system comprising: one or more battery cells; and one or more battery cell mounting devices, wherein each battery cell mounting device is interconnected with an associated one of the one or more battery cells, each battery cell mounting device comprising: one or more flexible retaining elements, wherein the flexible retaining elements make electrical contact with a crimped region of a mounted battery cell, wherein the flexible retaining elements are capable of physically supporting the mounted battery cell; and a substrate, wherein the substrate is operable to connect to a ground of the battery cell via the one or more flexible retaining elements.

Aspects of the above system include wherein an upper portion of the mounted battery cell extends above the substrate.

Aspects of the above system include wherein the one or more flexible retaining elements extend downward.

Aspects of the above system include wherein a contact point connected to a second substrate electrically contacts a terminal of the mounted battery cell.

Aspects of the above system include wherein the one or more flexible retaining elements comprise a hollow portion, wherein the hollow portion allows for a horizontal movement of the one or more flexible retaining elements.

Aspects of the above system include wherein the one or more flexible retaining elements comprise an interior point operable to hold the mounted battery cell at the crimped region.

Aspects of the above system include wherein the battery cell mounting device is connected to at least a second battery cell mounting device via the substrate.

Embodiments include a battery cell matrix mounting device, comprising: a substantially planar substrate; two or more cutouts disposed in portions of the substrate; and a plurality of battery cell retaining elements formed at a periphery of each of the two or more cutouts and in the substrate, wherein at least one of the plurality of battery cell retaining elements comprises a flexible region disposed at the periphery of the associated cutout, the at least one of the plurality of battery cell retaining elements having a first flexed battery cell receiving state and a second flexed battery cell retaining state, and wherein the plurality of battery cell retaining elements include a battery cell engagement feature sized to engage with and retain a crimped region of an attached battery cell.

Aspects of the above device include wherein an upper portion of the mounted battery cell extends above the substrate.

Aspects of the above device include wherein the one or more flexible retaining elements extend downward.

Aspects of the above device include wherein a contact point connected to a second substrate electrically contacts a positive terminal of the mounted battery cell.

Aspects of the above device include wherein the one or more flexible retaining elements comprise a hollow portion, wherein the hollow portion allows for a horizontal movement of the one or more flexible retaining elements.

Aspects of the above device include wherein the one or more flexible retaining elements comprise an interior point operable to hold the mounted battery cell at the crimped region.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A battery cell mounting device, comprising:
a substantially planar substrate;
a cutout disposed in a portion of the substrate; and
a plurality of battery cell retaining elements formed at a periphery of the cutout and in the substrate, wherein at least one of the plurality of battery cell retaining elements comprises a flexible region disposed at the periphery of the cutout, the at least one of the plurality of battery cell retaining elements having a first flexed battery cell receiving state and a second flexed battery cell retaining state, and wherein the plurality of battery cell retaining elements include a battery cell engagement feature sized to engage with and retain a crimped region of an attached battery cell.

2. The battery cell mounting device of claim 1, wherein an upper portion of the mounted battery cell extends above the substrate.

3. The battery cell mounting device of claim 1, wherein the one or more flexible retaining elements extend offset from the substrate in a direction toward the crimped region.

4. The battery mounting device of claim 3, wherein a contact point connected to a second substrate is operable to electrically contact a positive terminal of the mounted battery cell.

5. The battery cell mounting device of claim 3, wherein the one or more flexible retaining elements comprise a hollow portion, wherein the hollow portion allows for a horizontal movement of the one or more flexible retaining elements.

6. The battery cell mounting device of claim 3, wherein the one or more flexible retaining elements comprise an interior point operable to hold the mounted battery cell at the crimped region.

7. The battery mounting device of claim 1, wherein the battery cell mounting device is connected to at least a second battery cell mounting device via the substrate.

8. An energy storage system, the energy storage system comprising:
one or more battery cells; and
one or more battery cell mounting devices, wherein each battery cell mounting device is interconnected with an associated one of the one or more battery cells, each battery cell mounting device comprising:
one or more flexible retaining elements, wherein the flexible retaining elements make electrical contact with a crimped region of a mounted battery cell, wherein the flexible retaining elements are capable of physically supporting the mounted battery cell; and
a substrate, wherein the substrate is operable to connect to a ground of the battery cell via the one or more flexible retaining elements.

9. The energy storage system of claim 8, wherein an upper portion of the mounted battery cell extends above the substrate.

10. The energy storage system of claim 8, wherein the one or more flexible retaining elements extend downward.

11. The energy storage system of claim 10, wherein a contact point connected to a second substrate electrically contacts a terminal of the mounted battery cell.

12. The energy storage system of claim 10, wherein the one or more flexible retaining elements comprise a hollow portion, wherein the hollow portion allows for a horizontal movement of the one or more flexible retaining elements.

13. The energy storage system of claim 10, wherein the one or more flexible retaining elements comprise an interior point operable to hold the mounted battery cell at the crimped region.

14. The energy storage system of claim 8, wherein the battery cell mounting device is connected to at least a second battery cell mounting device via the substrate.

15. A battery cell matrix mounting device, comprising:
a substantially planar substrate;
two or more cutouts disposed in portions of the substrate; and
a plurality of battery cell retaining elements formed at a periphery of each of the two or more cutouts and in the substrate, wherein at least one of the plurality of battery cell retaining elements comprises a flexible region disposed at the periphery of the associated cutout, the at least one of the plurality of battery cell retaining elements having a first flexed battery cell receiving state and a second flexed battery cell retaining state, and wherein the plurality of battery cell retaining elements include a battery cell engagement feature sized to engage with and retain a crimped region of an attached battery cell.

16. The battery cell matrix mounting device of claim 15, wherein an upper portion of the mounted battery cell extends above the substrate.

17. The battery cell matrix mounting device of claim 15, wherein the one or more flexible retaining elements extend downward.

18. The battery cell matrix mounting device of claim 17, wherein a contact point connected to a second substrate electrically contacts a positive terminal of the mounted battery cell.

19. The battery cell matrix mounting device of claim 17, wherein the one or more flexible retaining elements comprise a hollow portion, wherein the hollow portion allows for a horizontal movement of the one or more flexible retaining elements.

20. The battery cell matrix mounting device of claim 17, wherein the one or more flexible retaining elements comprise an interior point operable to hold the mounted battery cell at the crimped region.
